(19) United States
(12) Patent Application Publication
(10) Pub. No.: US 2014/0109009 A1
(43) Pub. Date: Apr. 17, 2014

(54) METHOD AND APPARATUS FOR TEXT SEARCHING ON A TOUCH TERMINAL

(71) Applicant: TENCENT TECHNOLOGY (SHENZHEN) COMPANY LIMITED, Shenzhen (CN)

(72) Inventor: JIANJUN XU, Shenzhen (CN)

(73) Assignee: TENCENT TECHNOLOGY (SHENZHEN) COMPANY LIMITED, Shenzhen (CN)

(21) Appl. No.: 14/133,783

(22) Filed: Dec. 19, 2013

Related U.S. Application Data
(63) Continuation of application No. PCT/CN2013/071830, filed on Feb. 25, 2013.

(30) Foreign Application Priority Data
Feb. 28, 2012 (CN) 201210047477.6

(51) Int. Cl. G06F 3/0488; G06F 3/0484

(52) U.S. Cl. CPC G06F 3/0488; G06F 3/04842
USPC 715/810

(57) ABSTRACT

Various embodiments provide methods and apparatus for text searching on a touch terminal. In an exemplary method, the touch terminal can obtain a touch selection command. The touch terminal can interpret the touch selection command and determine text information corresponding to the touch selection command. The touch terminal can send the text information to a backstage server, and then receive and display search results returned from the backstage server and corresponding to the text information. Search results can thus be obtained by directly selecting text content on the touch terminal to trigger the backstage server to conduct a searching operation of the selected text content.

### CROSS-REFERENCES TO RELATED APPLICATIONS

This application is a continuation application of PCT Patent Application No. PCT/CN2013/071830, filed on Feb. 25, 2013, which claims priority to Chinese Patent Application No. CN201210047477.6, filed on Feb. 28, 2012, the entire contents of both of which are incorporated herein by reference.

### FIELD OF THE DISCLOSURE

The present disclosure relates to the field of communication technology and, more particularly, relates to methods and apparatus for text searching on a touch terminal.

### BACKGROUND

In today's network age, information volume is rapidly grown and information searching is increasingly demanded. There are two main ways to search the Internet for information: using a directory or using a search engine. When searching by the directory, a user may click on a directory as needed and go into a sub-directory to find corresponding information. This is convenient when searching for collective information of a certain type, but is often unsatisfied in accurately positioning the information. Search engines are commonly used for network searching. Once a user submits searching contents, search engines can provide a large amount of search results. These search results are arranged in an order of relevance to the searching contents.

With rapid development of mobile communication networks, searching operations are increasingly convenient when mobile phones, tablets, personal digital assistants (PDAs), and other mobile terminals are used. These searching operations are not limited by geographical locations and the time for searching. Information needed can thus be obtained as desired.

Currently, searching information on mobile devices may use keyboards to input text or use a voice command function to input corresponding contents to conduct the searching. Keyboards used for mobile devices may include physical ones that are configured on the mobile device and virtual ones that appear on a display interface of the mobile device.

However, problems arise for the mobile devices. Given the small size of the mobile devices, size of keys is very small regardless whether physical or virtual keyboards are used. Consequently, keys are often mistakenly pressed and/or undesired contents are entered. This may waste a large amount of time of mobile device users in order to input accurate contents for searching. In addition, many of mobile device users do not know or need to learn how to use certain inputting methods to input certain language characters (e.g., to use Pinying or Wubi to input Chinese characters).

For voice command based searching schemes, voice recognition technologies still need to be improved. For example, the recognition rate is generally not high enough, especially in a noisy environment. In some cases, local dialects cannot be recognized or cannot be accurately recognized by the mobile devices. Efficiency for voice inputting is therefore undesirably low.

There is a need to solve these and other problems and to provide methods and apparatus for text searching on a touch terminal for an easy text searching with improved accuracy and efficiency.

### BRIEF SUMMARY OF THE DISCLOSURE

Various embodiments provide methods and apparatus for text searching on a touch terminal. The disclosed methods and apparatus may be used, e.g., to easily input text information, to increase searching accuracy, and to improve searching efficiency, without using physical or virtual keyboards and/or without using a voice command function. The disclosed methods and apparatus may be implemented in a network environment such as a wireless network that involves at least one touch terminal.

According to various embodiments, there is provided a text searching method on a touch terminal. The touch terminal can obtain a touch selection command. The touch terminal can interpret the touch selection command to determine text information corresponding to the touch selection command. The touch terminal can send the text information to a backstage server, and then receive and display search results returned from the backstage server and corresponding to the text information.

According to various embodiments, there is also provided a touch terminal. The touch terminal can include an obtaining module, an interpreting module, a sending module, and a receiving module. The obtaining module can be configured to obtain a touch selection command. The interpreting module can be configured to interpret the touch selection command to determine text information corresponding to the touch selection command obtained by the obtaining module. The sending module can be configured to send the text information determined by the interpreting module to a backstage server. The receiving module can be configured to receive and display search results returned from the backstage server and corresponding to the text information.

According to various embodiments, there is further provided a text searching method on a touch terminal. The touch terminal can obtain a touch selection command without using a keyboard or a voice command function. The touch terminal can interpret the touch selection command to determine text information corresponding to the touch selection command. The touch terminal can send the text information to a backstage server, and then receive and display search results returned from the backstage server and corresponding to the text information.

In one embodiment, search results can be obtained by directly selecting text content on a display interface of a touch terminal to trigger a backstage server to perform a searching operation of the selected text content. The disclosed methods and apparatus can address the operational difficulties occurred when searching by inputting text or by voice commend on a terminal. The disclosed methods and apparatus can also improve searching efficiency and save time for users to obtain information.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts a flow diagram of an exemplary text searching method by a touch terminal in accordance with various disclosed embodiments;

FIG. 2 depicts an exemplary application of text searching on a touch terminal in accordance with various disclosed embodiments;

FIG. 3 depicts a structure diagram of an exemplary touch terminal in accordance with various disclosed embodiments;

FIG. 4 depicts an exemplary environment incorporating certain disclosed embodiments; and

FIG. 5 depicts an exemplary server consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

When searching text on a mobile terminal, low recognition rate exists for both keyboard input and voice input. Normal use and searching efficiency are thus adversely affected. As disclosed herein, a text searching method and apparatus on a touch terminal is provided, e.g., to easily input text information, to increase searching accuracy, and to improve searching efficiency, without using physical or virtual keyboards and/or without using a voice command function.

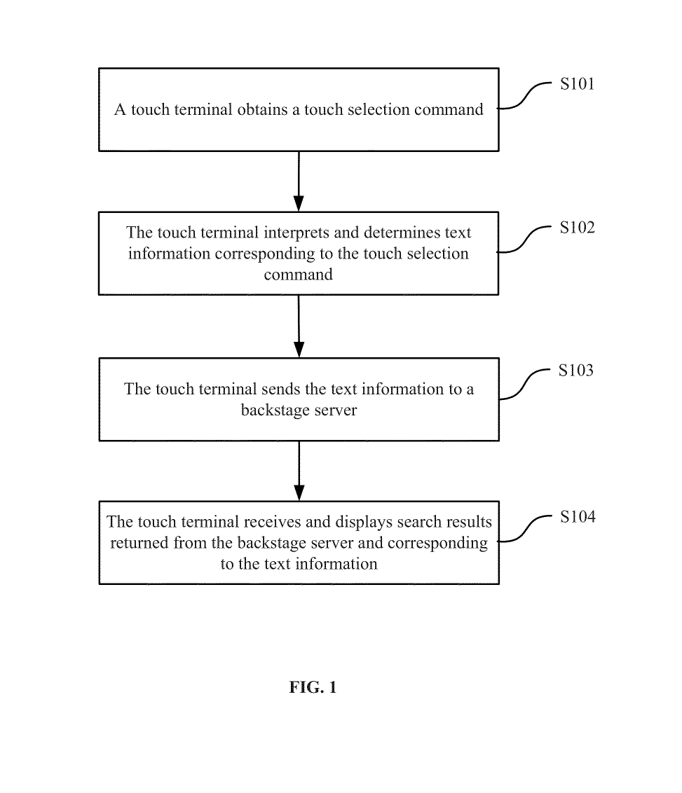

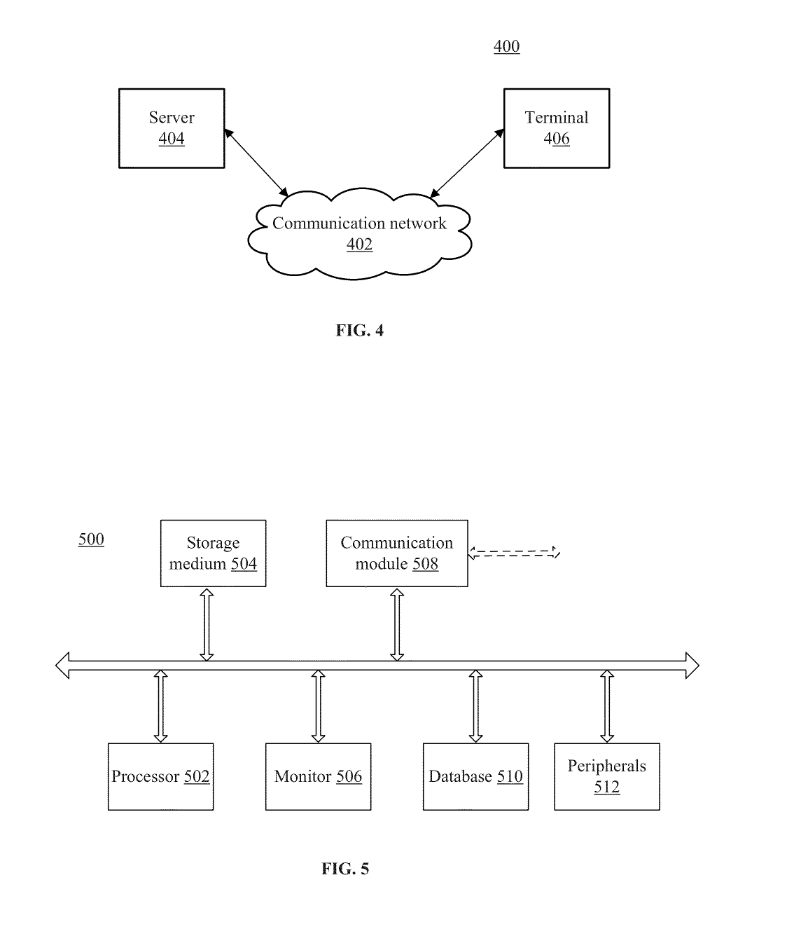

FIG. 1 depicts an exemplary text searching method on a touch terminal in accordance with various disclosed embodiments. The exemplary method can be implemented, for example, in an exemplary environment 400 as shown in FIG. 4.

FIG. 4 depicts the exemplary environment 400 incorporating the disclosed embodiments of the present disclosure. As shown in FIG. 4, environment 400 may include a server 404, a terminal 406, and a communication network 402. The server 404 and the terminal 406 may be coupled through the communication network 402 for information exchange, such as Internet searching, domain name resolution, etc. Although only one terminal 406 and one server 404 is shown in the environment 400, any number of clients 406 or servers 404 may be included, and other devices may also be included.

Communication network 402 may include any appropriate type of communication network for providing network connections to the server 404 and terminal 406 or among multiple servers 404 or clients 406. For example, communication network 402 may include the Internet or other types of computer networks or telecommunication networks, either wired or wireless. In a certain embodiment, the disclosed methods and apparatus may be implemented, for example, in a wireless network that includes at least one touch terminal.

A terminal (sometimes referred to as client), as used herein, may refer to any appropriate user terminal with certain computing capabilities, such as a personal computer (PC), a work station computer, a server computer, a hand-held computing device (tablet), a smart phone or mobile phone, a touch terminal, or any other user-side computing device. In various embodiments, the terminal may include a network access device. The terminal can be stationary or mobile.

A server, as used herein, may refer to one or more server computers configured to provide certain server functionalities, such as database management and search engines. A server may also include one or more processors to execute computer programs in parallel. In various embodiments, the server can be a backstage server. FIG. 5 shows a block diagram of an exemplary system for a server (such as a backstage server) and/or a terminal (such as a touch terminal).

As shown in FIG. 5, the exemplary system 500 may include a processor 502, a storage medium 504, a monitor 506, a communication module 508, a database 510, peripherals 512, and one or more bus 514 to couple the devices together. Certain devices may be omitted and other devices may be included.

Processor 502 may include any appropriate processor or processors. Further, processor 502 can include multiple cores for multi-thread or parallel processing. Storage medium 504 may include memory modules, such as ROM, RAM, and flash memory modules, and mass storages, such as CD-ROM, U-disk, removable hard disk, etc. Storage medium 504 may store computer programs for implementing various processes, when executed by processor 502.

Further, peripherals 512 may include I/O devices such as keyboard and mouse, and communication module 508 may include network devices for establishing connections through the communication network 402. Database 510 may include one or more databases for storing certain data and for performing certain operations on the stored data, such as database searching.

In operation, referring to FIG. 4, terminal 406 may cause server 404 to perform certain actions, such as an Internet search or other database operations. Server 404 may be configured to provide structures and functions for such actions and operations. For example, server 404 may include a data searching system for real-time database searching.

The disclosed text searching methods and apparatus can be implemented in the network environment 400 as depicted in FIG. 4. In one embodiment, the disclosed text searching methods and apparatus can be implemented, e.g., in a wireless network including at least one touch terminal.

As used herein, a “touch terminal” identifies a user-selectable, touch-responsive element on a display interface or a display interface for user communication, e.g., with a text searching or processing system. In one embodiment, a touch terminal can be a mobile terminal responsive to one or more operation(s), e.g., a touch selection operation, in a touch manner. The touch manner can include, e.g., tapping, sliding (e.g., “tapping and sliding” or “pressing and sliding”), and/or other suitable touching methods. The touch terminal can be stationary or mobile. The touch terminal can include, e.g., a mobile terminal, a smart phone, a tablet PC, an MP3, a PDA, and the like. In an embodiment, a touch terminal can be a touch pad.

As disclosed herein, operations on a touch terminal can be performed to directly input text content by a corresponding touch selection command. As used herein, a “touch selection command” refers to an operational command triggered when a touch terminal recognizes an operation or a combination of operations that follow pre-set (e.g., default) operational rules. Such operation or a combination of operations may be conducted by a user, e.g., in a touch manner, on a current display interface (e.g., a touch screen) of the touch terminal.

Referring to FIG. 1, in Step S101, a touch terminal obtains a touch selection command, e.g., further obtains text content selected by the touch selection command from a user. For example, the user can select text content in a manner: by touching the text content on a display interface of the touch terminal; or by touching (e.g., tapping) the text content on a display interface for more than a predefined number of times; and/or identified by touching (e.g., tapping) the start and end points of the text content on a display interface, after a text selection function is activated. Such operations or combination of operations are examples only for illustration purposes. Accordingly, other action rules can also be defined or used, which are intended to be encompassed in accordance with various disclosed embodiments.

When receiving a touch selection command, the touch terminal may also set the selected text content in a highlighted status on the current display interface. As such, the selected text content can be displayed as highlighted. Highlighting the selected text content is convenient for users to know and/or confirm whether the selected information is as wanted.

To confirm the selected text content, the touch terminal can further trigger a corresponding confirmation process. For example, the touch terminal can display a search confirming interface (e.g., having a search button) corresponding to the selected text content. In various embodiments, when the touch terminal receives a confirming notification, Step S102 in FIG. 1 can be performed. If the touch terminal does not receive a confirming notification within a pre-set timeframe or receives a negative notification, the touch terminal does not perform Step S102 and can directly terminate current searching operations. Such confirmation process may further increase input accuracy of the searching contents and avoid consumption of system resources generated due to invalid searching or wrong searching led by a mistaken input.

In Step S102, the touch terminal interprets the text content selected by the touch selection command and determines text information corresponding to the touch selection command. In Step S103, the touch terminal sends the text information to a backstage server. In various embodiments, the backstage server can be in a network environment as shown in FIG. 4, such as in a wireless network.

In Step S104, the touch terminal receives and displays search results returned from the backstage server and corresponding to the text information. In certain embodiments, the touch terminal may directly display on a current display interface: contents of the received search results; outline information of contents of the received search results; and/or link information corresponding to the received search results.

In certain embodiments, directly displaying the link information corresponding to the received search results may further include: accessing and displaying a page corresponding to the link information, if the touch terminal receives an operational command to activate the link information. The page corresponding to the link information may include search results corresponding to the text information corresponding to the touch selection command.

In various embodiments, displaying content outline information or link information can effectively save network transmission volume, but is less convenient compared with displaying full contents especially when a user needs to access information with details. Accordingly, users may select, as desired, which way to display or how much information to be displayed.

In one embodiment, when the network signal is sufficiently strong, for example, when using a Wi-Fi (i.e., wireless fidelity) access point to access a network, search results may be displayed by displaying full contents. In another embodiment, when the network signal is not sufficiently strong, for example, when using GPRS (i.e., a general packet radio service) to access a network, search results may be displayed by displaying content outline information or link information to save network data flow.

In this manner, search results can be obtained by directly selecting text content on a display interface of a touch terminal to trigger a backstage server to perform a searching operation of the selected text content. The disclosed methods and apparatus can address the operational difficulties occurred when searching by inputting text or by voice commend on a terminal. The disclosed methods and apparatus can also improve searching efficiency and save time for users to obtain information.

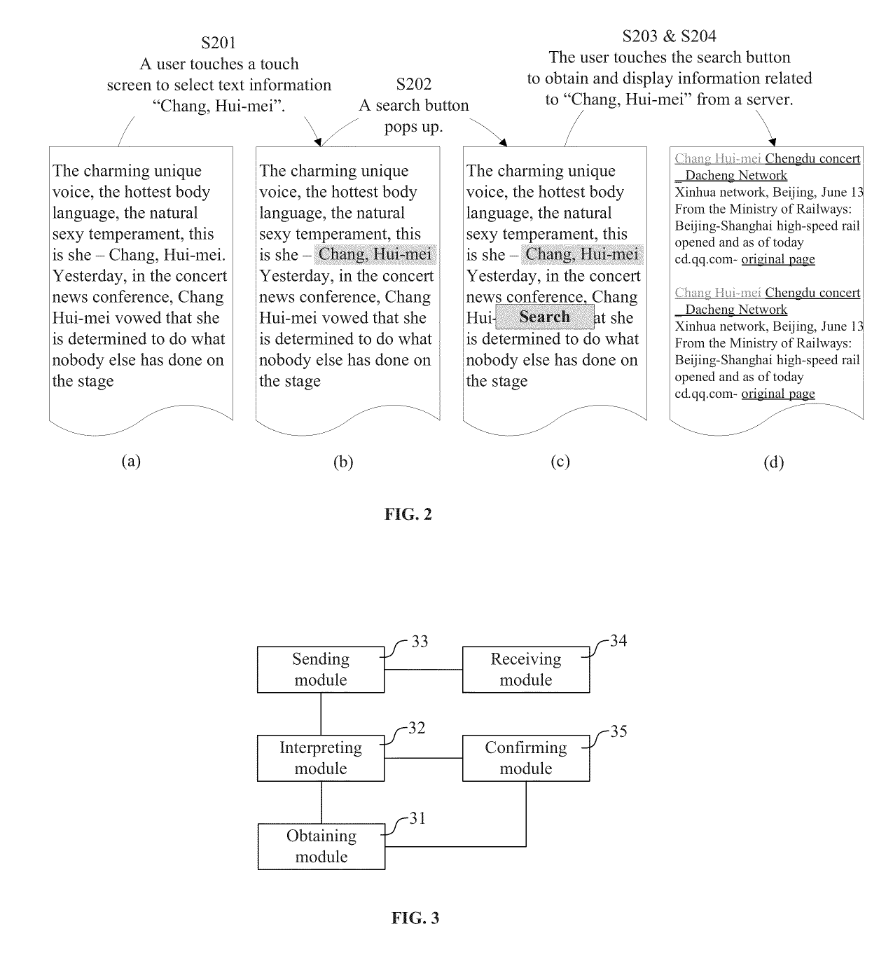

In an example, a user may directly tap a touch screen to select text content by a touch selection command on a touch terminal. The touch terminal can obtain text information corresponding to the touch selection command. A backstage sever can search related text information to obtain search results and return the search results to the touch terminal for the touch terminal to display. Searching speed and efficiency can then be increased. For example, FIG. 2 depicts an exemplary application for text searching on a touch terminal in accordance with various disclosed embodiments.

In Step S201, on a current Internet browsing interface, a user may touch (e.g., tap) a touch screen to select text content needed for searching (e.g., to select text content “Chang Hui-mei” as shown on an exemplary touch screen of FIG. 2(a)). The touch terminal may set the text content selected by the user in a highlighted status (e.g., the selected text content “Chang Hui-mei” is highlighted as shown in FIG. 2(b)).

When a user uses a touch terminal to search information from the Internet, the touch terminal can recognize actions operated by the user through the touch screen and display the user selected text content in a suitable manner. In various embodiments, the text content needed to be searched can be selected, for example, by sliding, tapping, or other suitable touching methods, on a display interface of the touch terminal. In one embodiment, the user may select the text content, e.g., by a horizontal sliding to select multiple characters in succession, or by tapping the touch screen to select one single character. In another embodiment, the touch terminal may highlight the text content selected by the user. Alternatively, the touch terminal may change font and/or color of the selected text content, or the touch terminal may directly display the selected text content on another window.

In Step S202, a window for confirming a searching operation (e.g., including a search button) pops up on the touch terminal for the user to decide if this searching operation is needed. If the user decides and confirms to conduct the searching operation, the touch terminal can interpret the selected text content (e.g., which is highlighted or otherwise displayed) and obtain corresponding text information. Step S203 can then be performed. If the user decides and confirms not to conduct the searching operation, the touch terminal does not conduct the interpreting operation and directly terminates the current searching operation.

The pop-up window for confirming the searching operation on the touch terminal may include contents including, e.g., if the searching operation needs to continue, if there are multiple search engines previously stored on the touch terminal for the user to select, and/or if the text content needs to be saved. When a searching operation is not needed, the user can touch a “cancel” button on the pop-up window or touch a blank space to terminate the searching operation.

In a specific embodiment, when the window for confirming the searching operation pops up on the touch terminal (e.g., with a search button popping up as shown in FIG. 2(c)) after the user has selected text content, the user may start the searching operation by touching a search confirming notification on the pop-up window or by touching the search engine. The user may also touch to save the selected text content. When the user confirms the searching operation, the touch terminal may interpret the highlighted text content selected by a touch selection command to obtain corresponding text information. When the user selects the text content by mistake or does not need to conduct a searching operation, the user may tap the cancel button on the pop-up window or tap a blank space to restore the highlighted text content to its original status (e.g., a non-highlighted status).

In Step S203, the touch terminal sends the obtained text information to a backstage server. The backstage server may include a server that stores information and provides inquiry services to the users. In Step S204, the touch terminal obtains and displays on the touch screen the search results sent by the backstage server.

After the touch terminal receives search results returned from the backstage server, the touch terminal may directly display the search results on the screen. Alternatively, the touch terminal may pop up with notifications for the user to decide whether or not: to open the search results; to save the search results; or to conduct another searching operation. As shown in FIG. 2(d), for example, two information links are displayed from the search results with a portion of text information displayed corresponding to the information links.

In this manner, search results can be obtained by directly selecting text content on a display interface of a touch terminal to trigger a backstage server to perform a searching operation of the selected text content. The disclosed methods and apparatus can address the operational difficulties occurred when searching by inputting text or by voice commend on a terminal. The disclosed methods and apparatus can also improve searching efficiency and save time for users to obtain information.

FIG. 3 depicts an exemplary touch terminal in accordance with various disclosed embodiments. The exemplary touch terminal can include an obtaining module 31, an interpreting module 32, a sending module 33, and/or a receiving module 34.

The obtaining module 31 is configured to obtain a touch selection command, which may select text content on a display interface (or a touch screen) of the touch terminal. The obtaining module 31 can include one or more obtaining modules such that multiple touch selection commands can be obtained in a same module or a separate module.

The interpreting module 32 is configured to interpret the touch selection command and determine text information corresponding to the touch selection command obtained by the obtaining module 31. The interpreting module 32 is also used to set the text content selected by the touch selection command in a highlighted status on a current display interface of the touch terminal.

The sending module 33 is configured to send the text information determined by the interpreting module 32 to a backstage server. The receiving module 34 is configured to receive and display search results returned from the backstage server and corresponding to the text information.

In various embodiments, the touch terminal also includes a confirming module 35. The confirming module 35 may be used, e.g., to display a search confirming interface corresponding to the text content after the obtaining module 31 obtains the touch selection command. The confirming module 35 may also be used to notify the interpreting module 32 to interpret the touch selection command and determine text information corresponding to the touch selection command, if a confirming notification is received. The confirming module 35 may further be used to notify the interpreting module 32 to abandon resolution of the text content, if a confirming notification is not received within a pre-set timeframe or if a negative notification is received.

The receiving module 34 can be configured to display, on the current display interface of the touch terminal, for example, contents of the received search results; content outline information of the received search results; and/or link information of the received search results.

In a specific embodiment, when the receiving module 34 displays link information of received search results, the receiving module 34 may receive an operational command to activate the link information. The receiving module 34 may notify the sending module 33 to obtain a page or webpage corresponding to the link information and then display the obtained page. The page may include search results corresponding to the text information according to the touch selection command.

In this manner, search results can be obtained by directly selecting text content on a display interface of a touch terminal to trigger a backstage server to perform a searching operation of the selected text content. The disclosed methods and apparatus can address the operational difficulties occurred when searching by inputting text or by voice commend on a terminal. The disclosed methods and apparatus can also improve searching efficiency and save time for users to obtain information.

In various embodiments, the disclosed modules can be configured in one apparatus or configured in multiple apparatus as desired. The modules disclosed herein can be integrated in one module or in multiple modules. Each of the modules disclosed herein can be divided into one or more sub-modules, which can be recombined in any manner.

The disclosed embodiments (e.g., as shown in FIGS. 1-5) can be examples only. One of ordinary skill in the art would appreciate that suitable software and/or hardware (e.g., a universal hardware platform) may be included and used in accordance with various disclosed embodiments. For example, the disclosed embodiments can be implemented by hardware only, which alternatively can be implemented by software products only. The software products can be stored in a storage medium. The software products can include suitable commands to enable a terminal device (e.g., including a mobile phone, a personal computer, a server, or a network device, etc.) to implement the disclosed embodiments.

Other applications, advantages, alternations, modifications, or equivalents to the disclosed embodiments are obvious to those skilled in the art.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Methods and apparatus for text searching on a touch terminal are provided herein. The disclosed methods and apparatus may be used, e.g., to easily input text information, to increase searching accuracy, and to improve searching efficiency, without using physical or virtual keyboards and/or without using voice command function.

The disclosed methods and apparatus may include at least one touch terminal, e.g., in a wireless network. In an exemplary method, a touch terminal can obtain a touch selection command. The touch terminal can interpret the touch selection command and determine text information corresponding to the touch selection command. The touch terminal can send the text information to a backstage server, and then receive and display search results returned from the backstage server and corresponding to the text information.

Search results can thus be obtained by directly selecting text content on the touch terminal to trigger the backstage server to conduct a searching operation of the selected text content. The disclosed methods and apparatus can address the operational difficulties occurred when searching by inputting text or by voice commend on a terminal. The disclosed methods and apparatus can also improve searching efficiency and save time for users to obtain information.

What is claimed is:

1. A text searching method on a touch terminal comprising:
obtaining a touch selection command by the touch terminal;
interpreting the touch selection command by the touch terminal to determine text information corresponding to the touch selection command;
sending the text information to a backstage server by the touch terminal; and
receiving and displaying search results by the touch terminal, wherein the search results are returned from the backstage server and corresponding to the text information.

2. The method of claim 1, wherein the touch selection command is an operational command triggered when the touch terminal recognizes an operation or a combination of operations, on a current display interface, that follow a pre-set operational rule.

3. The method of claim 1, wherein, after the touch selection command is obtained by the touch terminal, the method further comprising:
setting text content selected by the touch selection command in a highlighted status on a current display interface.

4. The method of claim 1, wherein, after the touch selection command is obtained by the touch terminal, the method further comprising:
displaying a search confirming interface corresponding to text content selected by the touch selection command; and
interpreting the text content selected by the touch selection command to determine the text information, if the touch terminal receives a confirming notification, or
abandoning resolution of the text content selected by the touch selection command, if the touch terminal does not receive a confirming notification within a pre-set timeframe or if the touch terminal receives a negative notification.

5. The method of claim 1, wherein the displaying of the search results comprises:
displaying contents of the search results on a current display interface; or
displaying outline information of contents of the search results on a current display interface; or
displaying link information corresponding to the search results on a current display interface.

6. The method of claim 5, wherein the displaying of the link information comprises:
accessing and displaying a page corresponding to the link information, if the touch terminal receives an operational command to activate the link information, wherein the page includes the search results corresponding to the text information.

7. A touch terminal comprising:
an obtaining module configured to obtain a touch selection command;
an interpreting module configured to interpret the touch selection command obtained by the obtaining module to determine text information corresponding to the touch selection command;
a sending module configured to send the text information determined by the interpreting module to a backstage server; and
a receiving module configured to receive and display search results returned from the backstage server and corresponding to the text information.

8. The touch terminal of claim 7, wherein the interpreting module is further configured to set text content selected by the touch selection command in a highlighted status on a current display interface of the touch terminal.

9. The touch terminal of claim 7, further comprising a confirming module configured:
to display a search confirming interface corresponding to text content selected by the touch selection command after the obtaining module obtains the touch selection command; and
to notify the interpreting module to interpret the text content selected by the touch selection command to determine the text information, if a confirming notification is received; or
to notify the interpreting module not to interpret the text content selected by the touch selection command, if a confirming notification is not received within a pre-set timeframe or if a negative notification is received.

10. The touch terminal of claim 7, wherein the sending module is configured to display, on a current display interface of the touch terminal, contents of the search results; content outline information of the search results; or link information of the search results.

11. The touch terminal of claim 10, wherein the receiving module displays the link information of the received search results includes: the receiving module receives an operational command to activate the link information, notifies the sending module to obtain a page corresponding to the link information and displays the obtained page, the page including the search results corresponding to the text information.

12. A text searching method on a touch terminal comprising:
obtaining a touch selection command by the touch terminal without using one or more of a keyboard and a voice command function;
interpreting the touch selection command by the touch terminal to determine text information corresponding to the touch selection command;
sending the text information to a backstage server by the touch terminal; and
receiving and displaying search results by the touch terminal, wherein the search results are returned from the backstage server and corresponding to the text information.

13. The method of claim 12, wherein the keyboard is a physical keyboard or a virtual keyboard.

14. The method of claim 12, wherein the touch selection command is obtained by pressing and sliding text content on a display interface of the touch terminal.

15. The method of claim 12, wherein the touch selection command is obtained by one or more of:
touching text content on a display interface of the touch terminal;
touching the text content on the display interface for more than a predefined number of times; and
touching a start point and an end point of the text content on the display interface.
